(19) United States
(12) Patent Application Publication
(10) Pub. No.: US 2007/0222799 A1
(43) Pub. Date: Sep. 27, 2007

(54) Method and apparatus for image upscaling

(75) Inventors: Hsin-Ming Lee, Taipei City (TW); Chi Hui Wang, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/388,282

(22) Filed: Mar. 24, 2006

(51) Int. Cl. G09G 5/00

(52) U.S. Cl. 345/667

(57) ABSTRACT

A circuit for upscaling an image. The circuit comprises an overampling unit and an upscaling unit. The oversampling unit receives an image signal, oversamples the image signal to generate an oversampled data stream, wherein a sampling rate of the oversampling unit is equal or greater than an output resolution of a first dimension. The upscaling unit is coupled to the oversampling unit and scales up a second dimension of the image to generate a 2-dimensional scaled-up image.

### BACKGROUND OF THE INVENTION

1. Field of the Invention

The invention relates to image scaling and, in particular, to upscaling an image with an analog to digital converter (ADC).

2. Description of the Related Art

In a graphic system, such as a computer system as well as television systems and cameras, images are generally represented by image data (e.g., RGB data or YUV data), with display signals generated therefrom, followed by image reproduction on a corresponding display screen.

In such a graphic system, the images may need to be scaled up before displaying on the corresponding display screen for one or more of several reasons. For example, a source image may be provided in one resolution (e.g., 160×120 image data from a CD-ROM decoder), and the image may need to be displayed on a larger display screen (e.g., 640×480 CRT screen). To take advantage of the larger display area, a graphics system upscales the source image.

In addition, with advancements in user interfaces, a user may want to have the image resized without maintaining the original aspect ratio. That is, the image may need to be upscaled by different factors in length and width. Thus, a user may specify, for example, that the image be doubled in height while enlarging the width dimension by a factor of 1.5, a requirement accommodated by well-designed graphic systems.

Graphic systems typically include special circuitry to upscale images. Examples of such circuitry include well-known graphics controller chips typically housed on a motherboard of a computer system and special chipsets provided with LCD panels of computer systems and video cameras.

While providing the upscaling functionality, the special circuitry may need to meet specific requirements of the environment. For example, if the special circuitry is used in a flat panel display, the circuitry may need to be compact. In addition, it may be desirable to minimize power consumed by the circuitry, particularly in portable applications (e.g., laptop computers).

In conventional graphic systems, both horizontal and vertical pixel data of a source image are scaled up in a digital domain, whereas, circuits for upscaling the source image both horizontally and vertically are required.

### BRIEF SUMMARY OF THE INVENTION

An embodiment of a circuit for upscaling an image comprises an oversampling unit and an upscaling unit. The oversampling unit receives an image signal, and oversamples the image signal to generate an oversampled data stream, wherein a sampling rate of the oversampling unit is equal to or greater than an output resolution of a first dimension. The upscaling unit is coupled to the oversampling unit and scales up a second dimension of the image to generate a 2-dimensional scaled-up image.

An embodiment of a method for upscaling an image comprises oversampling an image signal to generate an oversampled data stream, and upscaling the second dimension of the image to generate a 2-dimensional scaled-up image.

In the invention, only a one-dimensional digital upscaling unit is required to scale up both horizontal and vertical components of an image by any aspect ratio. Due to oversampling by an analog to digital converter (ADC), upscaling of the image is more resistant to noise and signal phase detection is also enhanced. In addition, no external memory such as a dynamic random access memory (DRAM) is required.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a circuit for upscaling an image according to an embodiment of the invention; and

FIG. 2 shows a method for upscaling an image according to an embodiment of the invention.

### DETAILED DESCRIPTION OF THE INVENTION

This description is made for the purpose of illustrating the general principles of the invention and should not be taken in a limiting sense. The scope of the invention is best determined by reference to the appended claims.

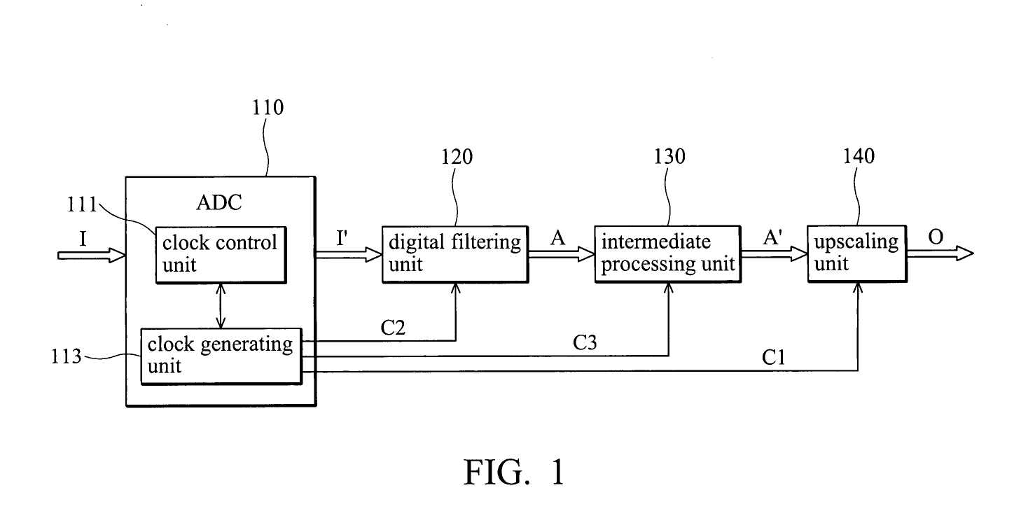

FIG. 1 is a block diagram of a circuit for upscaling an image according to an embodiment of the invention. The circuit 100 comprises an analog to digital converter (ADC) 110 and an upscaling unit 140. The analog to digital converter (ADC) 110 receives a 2-dimensional analog image signal I, and oversamples one dimensional component thereof, at a sampling rate equal to or greater than an output resolution of a first dimension, to generate an oversampled data stream. The upscaling unit 140 is coupled to the analog to digital converter (ADC) 110 and scales up a second dimension of the image to generate a 2-dimensional scaled-up image. An output signal O of the upscaling unit 140 includes scaled-up data streams of both horizontal and vertical components of the 2-dimensional analog image signal I. More specifically, the first dimension of the 2-dimensional analog image signal I is a horizontal dimension and the other a vertical dimension.

In the embodiment, the analog to digital converter (ADC) 110 comprises a clock control unit 111 and a clock generating unit 113. The clock control unit 111 generates control signals for controlling the clock generating unit 113. The clock generating unit 113 generates a sampling clock and provides a first clock signal C1 to the upscaling unit 140.

Additionally, the circuit 100 in FIG. 1 further comprises a digital filtering unit 120 coupled to the analog to digital converter (ADC) 110 and the upscaling unit 140. The digital filtering unit 120 receives the oversampled data stream from the analog to digital converter (ADC) 110 and a second clock signal C2 from the clock generating unit 113 and generates a filtered data stream. An output data stream A of the digital filtering unit 120 includes the filtered data stream.

Moreover, the circuit 100 in FIG. 1 further comprises an intermediate processing unit 130 coupled to the digital filtering unit 120 and the upscaling unit 140. The intermediate processing unit 130 receives a third clock signal C3 from the clock generating unit 113 and the filtered data stream. The intermediate processing unit 130 performs signal processing to the filtered data stream and generates an upscaled data stream of the first dimension of the 2-dimensional analog image signal I. An output data stream A′ of the intermediate processing unit 130 includes the upscaled data stream.

The analog to digital converter (ADC) 110 receives a source image signal from a data line or a data bus. The source image signal carries image information representing a plurality of 2-dimensional source image frames. Each source image frame is composed of a plurality of source scan lines, and each source scan line has a plurality of source pixel data. The number of the source image frames per second, number of source scan lines, and number of source pixel data are respectively represented by FRAME_src, LINE_src, and PXL_src. The circuit 100 generates and outputs a destination image signal to a data line or a data bus. The destination image signal comprises a plurality of destination image frames. Each destination image frame is composed of a plurality of destination scan lines, and each destination scan line comprises a plurality of destination pixel data. The number of the destination image frames per second, number of destination scan lines, and number of destination pixel data are respectively represented by FRAME_dst, LINE_dst, and PXL_dst.

The first dimension (horizontal dimension in this case) of the source image frame and the destination image frame determines a minimum oversampling ratio of the analog to digital converter (ADC) 110, F=PXL_dst/PXL_src. An example is described herein to explain various aspects of the upscaling method and circuit thereof. A source image signal of a VGA graphic signal with a frame rate of 60 Hz, and a destination image signal of a XGA graphic signal with a frame rate of 60 Hz are used as an illustration. In other words, FRAME_src, LINE_src, and PXL_src respectively equals 60, 480, and 640 and FRAME_dst, LINE_dst, and PXL_dst respectively 60, 768, and 1024. The minimum oversampling ratio F of the analog to digital converter (ADC) 110 is thus defined as 1024/640=1.6. As a result, an oversampling ratio of the analog to digital converter (ADC) 110 can be set to any number greater or equal to 1.6. In this example, the oversampling ratio is selected to be 2 for easy implementation. When a higher oversampling ratio is chosen for the analog to digital converter (ADC) 110, image integrity of the destination image signal is improved at the cost of power consumption, design convenience, and so on. The actual oversampling ratio is controlled by the clock control unit. Additionally, the analog to digital converter (ADC) 110 can be an adaptive analog to digital converter (ADC). When noise is coupled to the source image signal, or when a significant phase shift is introduced in the source image, taking more samples may prevent degradation. The adaptive analog to digital converter (ADC) can dynamically increase the oversampling ratio thereof and noise immunity is thus achieved.

In this example, the analog to digital converter (ADC) 110 provides an output data stream I′ to the digital filtering unit 120. In the output data stream I′, data of the horizontal component, which is the number of pixels per scan line, exceeds that required by the destination image. Thus, the digital filtering unit 120 filters the output data stream I′ and scales down the number of pixels per scan line such that the number of pixels per scan line in the output data stream A thereof equals to the number of pixels per scan line PXL_dst of the destination image signal. It is noted that data of the vertical component, which is the number of scan line per frame FRAME_dst is not yet up or down scaled.

The digital filtering unit 120 provides the output data stream A to the intermediate processing unit 130. The intermediate processing unit 130 generates the output data stream A′ which does not change the resolutions of the data stream A. The intermediate processing unit 130 performs only signal processing to the data stream A such that destination image quality is improved. More specifically, the intermediate processing unit performs image enhancement or image recovery to the oversampled data stream A.

The upscaling unit 140 receives the output data stream A′ from the intermediate processing unit 130 and scales up only data of the vertical component, that is, the number of scan lines per frame. An output data stream 0 generated by the upscaling unit 140 carries 2-dimensional upscaled image data of the source image. Since the upscaling unit 140 scales up only the vertical component, an embodiment of the upscaling unit 130 comprises a built-in buffer for storing data belonging to a number of scan lines, and the vertical upscaling may be simply achieved by linear interpolation or other well known algorithms.

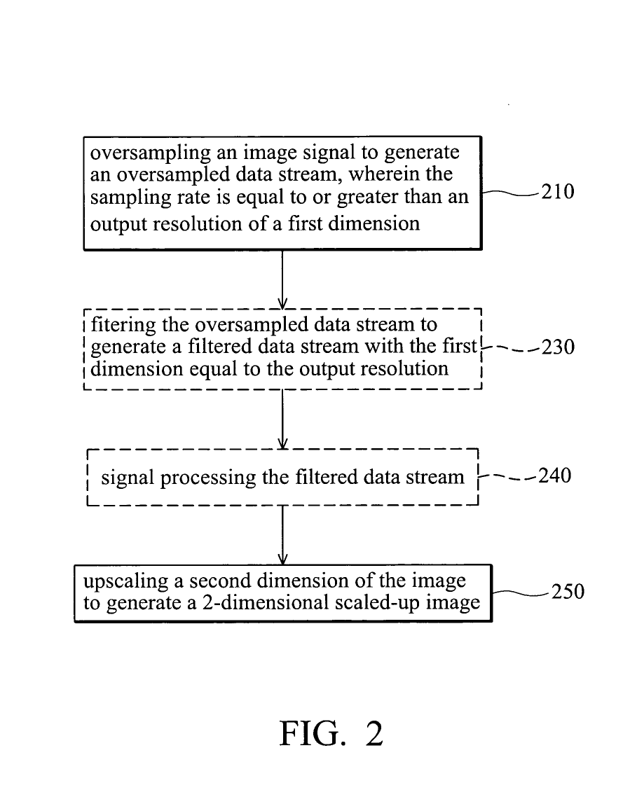

FIG. 2 shows a method for upscaling an image according to an embodiment of the invention. The method comprises oversampling an image signal, at a sampling rate equal to or greater than an output resolution of a first dimension, to generate an oversampled data stream (step 210), and upscaling a second dimension of the image to generate a 2-dimensional scaled-up image (step 250). Moreover, oversampling ratio of dimensional component oversampling is dynamically adjusted such that data transmission is more resistant to noise. More specifically, the first dimension is a horizontal dimension and the second is a vertical dimension. In addition, the method can further comprise filtering the oversampled data stream to generate a filtered data stream with the first dimension equal to the output resolution (step 230) and signal processing the filtered data stream (step 240). More specifically, the signal processing may be image enhancement or image recovery.

Certain terms are selected throughout the description and claims to refer to particular system components. As one skilled in the art will appreciate, consumer electronic equipment manufacturers may refer to a component by different names. This document does not intend to distinguish between components that differ in name but not function. In the discussion and following claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A circuit for upscaling an image, comprising:
an oversampling unit receiving an image signal, and oversampling the image signal to generate an oversampled data stream, wherein a sampling rate of the oversampling unit is equal to or greater than an output resolution of a first dimension; and
an upscaling unit coupled to the oversampling unit for scaling up a second dimension of the image to generate a 2-dimensional scaled-up image.

2. The circuit as claimed in claim 1, wherein the oversampling unit comprises an analog to digital converter (ADC).

3. The circuit as claimed in claim 1, wherein the upscaling unit scales up a vertical dimension and the first dimension is a horizontal dimension.

4. The circuit as claimed in claim 1, wherein the oversampling unit is adaptive and capable of dynamically adjusting the sampling rate according to an oversampling ratio.

5. The circuit as claimed in claim 4, wherein the oversampling ratio is greater than or equal to the output resolution of the first dimension divided by an input resolution of the first dimension.

6. The circuit as claimed in claim 1, further comprising a clock generating unit generating a sampling clock for the oversampling unit and a first clock signal for the upscaling unit.

7. The circuit as claimed in claim 1, further comprising a digital filtering unit, coupled to the oversampling unit and the upscaling unit, receiving and filtering the oversampled data stream to generate a filtered data stream with the first dimension equal to the output resolution.

8. The circuit as claimed in claim 1, further comprising an intermediate processing unit, coupled to the oversampling unit and the upscaling unit, receiving and signal processing the oversampled data stream and outputting the processed data stream to the upscaling unit.

9. The circuit as claimed in claim 8, wherein the intermediate processing unit performs image enhancement or image recovery to the oversampled data stream.

10. A method for upscaling an image, comprising:
oversampling an image signal to generate an oversampled data stream, wherein the sampling rate is equal to or greater than an output resolution of a first dimension; and
upscaling a second dimension of the image to generate a 2-dimensional scaled-up image.

11. The method as claimed in claim 10, wherein the first dimension is a horizontal dimension and the second is a vertical dimension.

12. The method as claimed in claim 10, wherein the sampling rate is dynamically adjusted according to an oversampling ratio.

13. The method as claimed in claim 10, further comprising filtering the oversampled data stream to generate a filtered data stream with the first dimension equal to the output resolution.

14. The method as claimed in claim 10, further comprising signal processing the oversampled data stream.

15. The method as claimed in claim 14, wherein the signal processing comprises image enhancement or image recovery.
